(19) United States
(12) Patent Application Publication
(10) Pub. No.: US 2024/0141239 A1
(43) Pub. Date: May 2, 2024

(54) NAPHTHALENE TYPE POLYMERS AS SOLID HYDROGEN TRANSFER AGENTS (SHTA), COMBINED WITH HYDROTREATING CATALYSTS TO OBTAIN ULTRA LOW SULFUR DIESEL (ULSD)

(71) Applicant: Instituto Mexicano del Petróleo, Mexico City (MX)

(72) Inventors: Laura Olivia Alemán Vázquez, Mexico City (MX); Fernando Alonso Martínez, Mexico City (MX); Flavio Américo Lagos Galván, Mexico City (MX); María del Rosario Socorro Luna Ramírez, Mexico City (MX); León Pablo Torres Mancera, Mexico City (MX); GRodolfo Aguilar Escalante, Mexico City (MX); Jorge Ancheyta Juárez, Mexico City (MX)

(21) Appl. No.: 18/498,496

(22) Filed: Oct. 31, 2023

(30) Foreign Application Priority Data
Oct. 31, 2022 (MX) MX/A/2022/013720

(51) Int. Cl. C10G 47/34; C08G 63/66; C10G 45/04

(52) U.S. Cl. CPC C10G 47/34; C08G 63/66; C10G 45/04; C10G 2300/1044; C10G 2300/202; C10G 2400/04

(57) ABSTRACT

The present disclosure involves application of heterogeneous hydrogen donors (DHH) or solid hydrogen transfer agents (SHTA) prepared from a polymer with units containing the structure of naphthalene, phenanthrene or anthracene, which can be supported, anchored or in physical mixture with metal oxides such as alumina, silica, titania or kaolin and/or mixture of them, to be used in beds combined with an ULSD or non-ULSD HDS catalyst, to obtain ultra-low sulfur diesel in cuts and/or streams derived from petroleum and/or a mixture thereof, such as SRGO, kerosine, jet fuel, naphtha, etc. The SHTA of the present disclosure provide an additional amount of hydrogen atoms facilitating the removal of refractory sulfur compounds in the HDS process.

### CROSS-REFERENCE TO RELATED APPLICATIONS

This patent application claims priority under 35 U.S.C. Section 119 to Mexican Patent Application No. MX/a/2022/013720, filed Oct. 31, 2022, the entire disclosure of which is incorporated herein by reference.

### FIELD

The present disclosure relates to applications of Heterogeneous Hydrogen Donors (HHD), also called solid hydrogen transfer agents (SHTA). The SHTA synthesized in the present disclosure works as an extra source of hydrogen favoring pre-hydrogenation in the hydrodesulfurization process. The SHTA has been developed to obtaining ultra-low sulfur diesel (ULSD), by means of loading into a fixed bed reactor a ULSD hydrodesulfurization catalyst or also a non-ULSD hydrodesulfurization catalyst, packed in beds combined with a SHTA.

### BACKGROUND OF THE DISCLOSURE

Liquid hydrogen donors or liquid hydrogen transfer agents such as tetralin or decalin have limited industrial application due to their high cost and the difficulty in separating them from the mixture of reaction products. A new type of solid hydrogen donors, consisting of polymers that contain in their structure units with two or more fused aromatic, alicyclic or heterocyclic rings, are reported in US patent 862,658 B2. The synthesis of a polyester-type polymer derived from 1,5-dimethylnaphthalene, and terephthalic acid, poly-(1,4-bis(1,5-naphthalenediol)benzenedicarboxylate) was reported. This polymer is physically mixed with an inert support such as alumina, silica, titania, etc., subsequently activated with a hydrogenating agent, to ensure the transfer of hydrogen atoms from the polymer to the reaction, facilitating the breaking of double bonds in unsaturated chemical structures, such is the case of the hydrodesulfurization reaction.

It has been shown that Heterogeneous Hydrogen Donors (HHD) or Solid Hydrogen Transfer Agents (SHTA) are thermally and chemically stable to the reaction conditions for the upgrading of heavy crude oils (400-470° C.) patent U.S. Ser. No. 10/077,334 B2 and for HDS reactions (350-370° C.), these materials, being solid, are easily separated from the reaction products and for their industrial application they are mixed or supported in different inert solids such as SiO₂, kaolin or Al₂O₃, TiO₂, etc., which provide adequate mechanical and textural properties (U.S. Ser. No. 10/077,334 B2).

Hydrogenation reactions are disadvantaged by a limited availability of hydrogen that must be transferred to the liquid before starting the reaction and by the use of a low hydrogen partial pressure. Solid Hydrogen Transfer Agents (SHTA) prepared from polymers with units containing the structure of naphthalene, phenanthrene or anthracene, dehydrogenate, transferring hydrogen atoms to the reaction medium.

Mexican patent MX/a/2014/013477 (US 862,658 B2) refers to the use of naphthalene-based polymers or copolymers, particularly polyester-type polymers with naphthalene units in hydrogenation reactions. The synthesis of two polymers is described: (Poly-(1,4-bis(1,5-naphthalenedioxy) benzenedicarboxylate)) and (Poly-(2,2′-bis(1,5-naphthalenedioxy) diphenyldicarboxylate)).

The Mexican patent application MX/a/2015/010173 (U.S. Ser. No. 10/077,334 B2) refers to the application of polyester type polymers (Poly-(1,4-bis(1,5-naphthalenedioxy) benzenedicarboxylate)) and (Poly-(2,2′-bis(1,5-naphthalenedioxy) diphenyldicarboxylate)) with naphthalene-type subunits as hydrogen donors or solid hydrogen transfer agents in the hydrotreatment or hydrocracking of heavy and extra-heavy hydrocarbons.

U.S. Pat. No. 3,413,212 describes a process for improving the properties of hydrocarbon cuts with a boiling temperature above 204° C. using a crystalline aluminum silicate catalyst and a hydrogen transfer agent (liquid hydrogen donor) in the range temperature of 290-593° C. in order to obtain hydrocarbon fractions within the range of gasoline. The hydrogen donor is formed from the partial hydrogenation of polynuclear aromatic compounds, such as 1,2,3,4-tetrahydronaphthalene and decahydronaphthalene, following a hydrogen transfer mechanism under the presence of the catalytic material.

U.S. Pat. No. 4,642,175 refers to the coke reduction of heavy hydrocarbons when they are treated with naphthenates containing transition metals at temperatures less than 350° C. The product presents stability and can be used in subsequent processes such as catalytic and thermal cracking, including viscosity reduction and coking, with improvement in liquid yields and carbon reduction.

U.S. Pat. No. 4,395,324 describes the use of a tetralin-type low-boiling hydrogen transfer agent in a cracking process.

U.S. Pat. No. 4,696,733 discloses a process for the total or partial hydrogenation of polynuclear aromatic compounds with manganese in the presence of hydrogen at elevated temperatures. The resulting partially hydrogenated products are useful as hydrogen transfer agents in the thermal cracking process.

U.S. Pat. No. 4,485,004 claims a process for the conversion of heavy hydrocarbons to light products by hydrocracking in the presence of a hydrogen transfer agent with a boiling point above 200° C. and a hydrogenation catalyst formed from cobalt, molybdenum, nickel, tungsten and blends thereof.

U.S. Pat. No. 7,594,990 B2 describes a process where a hydrogen-donating solvent is used to maximize the conversion of residua in the boiling bed residua cracking process. The hydrogen-donating solvent precursor is produced by hydro-reforming reactions in the hydrocracking of residua. In this process, the hydrogen-donating solvent effectively retards coke formation at higher operating temperatures.

British patent GB 767,592 describes a process and system for converting crude oil into more volatile products by thermal cracking of oils in the presence of a hydrogen donor diluent, such as aromatic streams, in which the purpose of the hydrogen donor is to transfer the hydrogen within the diluent to the heavier fractions in order to prevent the formation of coke during thermal cracking or coking operations.

British patent GB 784,136 claims a thermal cracking process to generate lighter products using hydrogen donor diluents which are hydrogenated hydrocarbons from a stream with a boiling temperature between 260-593° C. with substantial proportions of aromatic hydrocarbons with fused rings.

U.S. Pat. No. 3,413,212 discloses a process for improving the properties of hydrocarbon cuts with a boiling temperature above 204° C. to obtain hydrocarbon fractions within the range of gasoline using a hydrogen transfer agent at the temperature of 290-593° C. through a crystalline aluminum silicate catalyst. The hydrogen transfer agent is formed from the partial hydrogenation of polynuclear aromatic compounds, preferably 1,2,3,4-tetrahydronaphthalene and decahydronaphthalene, following a hydrogen transfer mechanism in the presence of the catalytic material.

Canadian patent CA 1,122,914 claims a process for improving the properties of heavy hydrocarbon oils such as specific gravity, viscosity and boiling point using a hydrogen transfer agent under hydrocracking conditions, where an effluent with a boiling range between 82-177° C. it is re-hydrogenated and recycled to the hydrocracking zone at a temperature of 300-570° C. An 11.1° API bitumen is converted to a 19.3° API crude oil.

Canadian patent CA 1,144,501 discloses a process for upgrading heavy oil by mixing it with a hydrogen-donating diluent and subjecting it to catalytic cracking to obtain higher-value hydrocarbons. In this way, a fraction of diesel generated in the aforementioned process is subjected to hydrotreatment to recombine it with heavy oil in a new process.

Canadian patent CA 1,152,924 describes a process for converting high-boiling crude oil containing metals and at least 5% asphaltenes into an upgraded crude oil using a hydrogen-donating solvent at a pressure of 40-200 bar, temperature of 400-450° C. and an liquid hourly space velocity (LHSV) of 0.8-1.5 h⁻¹.

U.S. Pat. No. 4,294,686 claims a process for upgrading heavy crude oil by combining it with a hydrogen-donating diluent obtained from a hydrogenated light cyclic oil and subjecting it to catalytic cracking at a pressure of 2.5-6 MPa, at a temperature of 400-460° C. and an LHSV of 0.8-7.0 h−1 to obtain higher value hydrocarbons. Subsequently, a diesel fraction is hydrotreated to recombine it with heavy oil in a new process.

In U.S. Pat. No. 4,363,716 disclosed a hydrogen-donating solvent based on tetralin and naphthalene is claimed to improve heavy hydrocarbons to lighter products at temperatures of 250-800° C. and residence times of 15 seconds to 5 hours, with subsequent removal of the atmospheric fraction between 175-300° C. and subjecting the reaction to hydrogenation with a metal catalyst to regenerate the material.

U.S. Pat. No. 4,389,303 claims a process to convert a high-boiling crude oil into light products with a hydro-viscosity-reducing donor solvent that comprises mixtures of distillates between 200-500° C. of a naphthenic base and is reacted with crude oil at pressure 40-200 bars, 400-450° C. and LHSV of 0.5-2 h−1.

U.S. Pat. No. 4,389,303 discloses a process for hydro-reducing the viscosity of a crude oil at temperatures of 400-450° C., without a catalyst in the presence of a hydrogen-donating solvent, derived from the same crude oil or a similar crude oil and molecular hydrogen. At pressures of 120-150 bar, LHSV of 0.8-1.5 k/I-h and gas circulation between 400-2000 m3/Tm, it is achieved the conversion of crude oils with high boiling point (between 200 and 530° C.) and high content of residue, metals and asphaltenes (5%). The concentration of naphthalene remains constant in the circulation system and in the viscosity reducer, allowing the crude oil residue to be converted into distillable components, through a molecular rearrangement of hydrogen.

U.S. Pat. No. 4,363,716 refers to a cracking process at 250-475° C., with a short residence time (10 min-5 h) to improve the properties of the heavy fractions, favoring selectivity towards distillates and reducing coke; through a hydrogen donor solvent obtained from the feedstock (C₁₀-C₁₄), which is recirculated to the reaction zone after hydroprocessing; In particular, tetralin, alkyltetralins, dihydronaphthalene and dihydroalkylnaphthalene are mentioned as hydrogen transfer agents. Hydroprocessing involves hydrogenation with solid-metallic-base catalyst (Ni—Mo, Co—Mo, Ni—W) or hydrogenation followed by hydroisomerization with solid-acid catalyst (Si—Al, Si—Mg—Si—Al—Zr, acid crystalline zeolites, phosphoric acid in kieselguhr), to form hydrogenated 2-ring aromatic compounds with P.E. 175-300° C., up to 30 weight %.

U.S. Pat. No. 4,592,830 refers to a viscosity hydro-reduction process for heavy fractions with a boiling temperature higher than 538° C. using a hydrogen-donating solvent (tetralin), obtained from the same crude oil. By heating the crude oil, with hydrogen and the solvent, under viscosity-reducing conditions (380-480° C.), a reduction in the heavy fraction in the feed is achieved. Molybdenum compounds, either dithiophosphates or dithiocarbamates, are used at a concentration up to 1000 ppm on the total feed plus solvent. The reaction time is up to 10 h, preferably 3 h and an operating pressure between to 3000 psig. A greater reduction of solids is achieved when using the hydrogen donor solvent compared with the process without it.

U.S. Pat. No. 4,604,186 discloses the reduction of coke in heavy crude oil fractions (370-510° C. boiling point) by combining hydrogen transfer agents with the feed in a viscosity reducer and a coker (either delayed or fluid); establishing that, by controlling the amount of hydrogen transfer agents in both units, the amount of coke produced is controlled. The heavy portion of the reducer effluent conforms the feed to the coker; and the aromatic gas fraction from the coker dome corresponds to the hydrogen transfer agent stream that is recycled to the reducer. The operating temperature of the coker and the viscosity reducer is 370-510° C. and 427-525° C., respectively. The hydrogenated diesel is mixed with the waste in a proportion of 0.2 to 2% by weight.

U.S. Pat. No. 4,615,791 claims a process for reducing the viscosity of heavy crude oil residua in a reaction time equivalent to 800 sec at 427° C., in the presence of highly aromatic hydrogen transfer agents in a proportion of 0.1 to 50% by weight. obtaining low viscosity products, the amount of the hydrogen transfer agent with respect to the residual heavy crude oil was 20% weight. The source of the hydrogen transfer agents may be from the FCC process or a product of non-petroleum origin. The viscosity reducing unit works with severity between 500 and 800 seconds (equivalent reaction time), temperatures between 350-485° C. and residence time between 1 and 60 minutes. The amount of the hydrogen transfer agent was 0.1 to 20% weight of the heavy crude oil.

U.S. Pat. No. 4,640,765 discloses a method for cracking heavy crude oils with at least 1% asphaltenes, without suffering pressure drops due to coking of the cracking towers. The authors describe a series of stages, among which are mentioned: a) dividing the interior of the cracking tower into at least two portions, both communicating at the top; b) introduce the heavy fraction of the crude oil, the hydrogen transfer agent and hydrogen gas; c) circulate the fluid maintaining a temperature between 380-470° C., pressures of 30-150 k/cm2 and flow rates of 1 cm/sec in the tower. Considering residence time between 0.2 and 10 h. The hydrogen transfer agent is defined as a polycyclic aromatic hydrocarbon hydride with at least 30% by weight of polycyclic aromatic hydrocarbons. The applicable catalyst is of the metal oxides and sulfides type, of group VII and VI on alumina, silica, Si—Al, Al—B, Si—Al—B, Si—Al—Mg, Si—Al-Titanium or zeolites either natural or synthetic, in a continuous process at 5-100 cm/sec with a residence time of 30 min preferably. The fluid is unloaded from the dome and the solvent fraction is recirculated.

US patent No. 272,038 claims a process to cracking the heavy fraction of crude oil, with an asphaltenes content of 1%, with a catalyst (hydrodemetallizing and hydrodesulfurizing), maximum 20% v; and a hydrogen transfer agent such as tetralin whose aromatic content must be greater than 30%. The circulation of a gas containing hydrogen inhibits the formation of coke. It establishes a subsequent hydrogenation of the reaction products in the presence of a solid catalyst, maintaining the hydrogen flow to avoid clogging. Crude oil and solvent circulate at 2 cm/sec, LHSV maximum 1 h⁻¹ (crude/catalyst). The temperature and pressure in the disintegration reactor are maintained between 380-470° C. and 30-150 k/cm² respectively, and the temperature and pressure values in the hydrogenation reactor are fixed at: 330-440° C. and 30-150 k/cm².

U.S. Pat. No. 4,857,168 describes a process for the hydrocracking of heavy crude oil fractions by applying a hydrogen transfer agent as a solvent, hydrogen gas and a catalyst capable of hydrogenating in the reactor at temperatures of 380-470° C. and pressures of 30-150 kg/cm². The hydrogen transfer agent inhibits the formation of carbonaceous substances and is discarded; but the tetralin concentration is kept fixed or at a higher level. The process is applied to feedstocks with asphaltene content between 10-30%, where 50% of the load has a boiling temperature of 350° C. The catalyst used has a demetallizing function and two fixed bed reactors are employed (cracking and hydrogenation).

U.S. Pat. No. 4,966,679 states that, by means of a catalyst, a hydrogen transfer solvent (tetralin), and the addition of hydrogen in a cracking reactor, it is possible the hydrocracking of heavy crude oil fractions into light products. The hydrogenation of the reaction products in the presence of a solid catalyst and a stream of hydrogen allows the conversion of those insoluble in toluene to compounds soluble in toluene, thus avoiding clogging of the equipment. The catalyst is added at 50-70% volume for cracking and 60-95% volume for hydrogenation. Maintaining a linear liquid velocity of 3.5 cm/sec to avoid pressure drop. In one part of the reactor, 20% vol. of the catalyst, the crude oil and solvent circulate at a speed of 2 cm/sec around one of the reactor partitions. The hydrogen transfer solvent is composed of polycyclic aromatic hydrides (30% aromatics). Catalyst with hydrodemetalizing function in the cracking reactor (380-470° C., 30-150 k/cm²), and with hydrodesulfurizing function in the hydrogenation reactor (330-440° C., 30-150 k/cm²).

U.S. Pat. No. 4,592,830 refers to a viscosity hydro-reduction process for heavy fractions with boiling temperatures above 538° C., using a hydrogen transfer agent (tetralin), obtained from the same crude oil. By heating the crude oil, with hydrogen and the solvent and under viscosity-reducing conditions (380-480° C.), a reduction in the amount of heavy substances in the feed is achieved. Molybdenum compounds, either dithiophosphates or dithiocarbamates, are used at a concentration of up to 1000 ppm on the total feed plus solvent. The reaction time is up to 10 h, preferably 3 h. Operating pressure between 500 to 3000 psig. With the hydrogen transfer solvent, further solids reduction is achieved.

The previous patents refer to the usage of liquid hydrogen donor agents such as tetralin or aromatic streams obtained from the distillation of crude oil, in mixture with catalysts or without catalysts to carry out hydrogenation reactions, mainly for the upgrading of heavy crude oils, but no patents were found where hydrogen donors or SHTA are used to obtain diesel with low sulfur content.

Below, some patents are described that refer to the using of combined beds of HDS catalysts to obtain diesel with low sulfur content, but none of them talk about the use of SHTA with HDS catalysts to obtain ULSD, which is the object of the present disclosure.

Patent application US 2018/0232499 A1 refers to a method to achieve improved catalytic behavior via a strategic arrangement of multiple catalyst beds, based on the kinetic properties of the catalysts.

The application describes a process to maximize the performance of a catalytic system comprising systematically and consistently at least two different catalysts. A method is described to select the optimal catalyst stacking order depending mainly on the reaction order calculated for each catalyst. It is suggested to place the catalyst with a higher reaction order on the top and one with a lower reaction order on the bottom, in a multiple-bed scheme, which can save time and money at testing. A synergistic effect on the HDS behavior of the combined catalytic system can be observed when the catalysts loaded into the reactor follow a trend of increasing activity from top to bottom. For HDS reactions, the catalyst with the highest reaction rate could maximize its conversion due to the high sulfur content in the feed at the first reaction zone. The catalyst placed at the end of the catalytic bed should be less reaction rate sulfur sensitive, thus a minimum sulfur concentration could be reached.

US 2011/0079542 A1, deals with the use of reactivated catalysts; Many refineries avoid the reuse of reactivated catalysts, because it is believed that the specifications for ULSD can only be achieved with fresh, highly active catalysts, however, stacking a reactivated catalyst on top of a fresh highly active catalyst can successfully produce ULSD.

The patent application proposes a dual stacking system where a rejuvenated catalyst is placed on top, comprising 10 to 50% of the total bed volume, and a fresh, high-activity catalyst is placed on the bottom, using 50-90% of the total bed volume, for a deep HDS process. The HDS activity of a regenerated catalyst needs to be in a range of 75-90% of the activity of the fresh catalyst, to produce a distillate with less than 10 ppm sulfur and avoid excessive costs associated with high activity catalysts.

Patent application US 2014/0305843 A1 describes a low-pressure process for HDS and HDN of a gas oil, the process uses a multi-bed system, the packed bed reactor includes CoMo catalysts supported on alumina, the second bed includes an alumina supported NiMo catalyst, preferably including an additive. The packed bed arrangement with the use of specific catalysts provides a low-pressure process and significantly improved HDS and HDN activity with negligible differences in hydrogen consumption.

The application protects a low-pressure process for diesel HDS and HDN, using a packed bed system comprising at least three catalytic beds; the first bed is a CoMo catalyst supported on alumina, the second bed is a NiMo catalyst with an additive and the third is a CoMo supported on alumina, the diesel is fed to the reaction zone that is operated at low pressure. The first catalytic bed occupies 5 to 25% of the total bed volume, the second bed occupies 10 to 50% of the total bed volume and the third 25 to 85% of the total volume. The low-pressure process operates in a range of 300 to 650 psig. The diesel charge has a T90<less than 750° F. and T10 greater than>300° F., obtaining a hydrotreated product with reduced sulfur and nitrogen content.

Patents Refer to the Preparation of Catalysts for Hydrotreatment

WO 2012/127128 A1. This invention relates to a catalyst that includes an alumina support, a C₁-C₄ dialkylsuccinate, nitric acid, phosphorus and a hydro-dehydrogenating function that includes at least one element from group VIII and at least one element from group VIB. The method of preparation of said catalyst is described, in which the catalytic precursor is dried, calcined or regenerated, the catalyst contains elements with a hydro-dehydrogenating function, and optionally phosphorus, which is impregnated from a solution with a C₁ dialkylsuccinate. C₄, citric acid and a phosphorus compound and optionally acetic acid, is subsequently dried. The catalyst is used in the hydrotreating process.

Patent application MX2012013217 relates to the preparation of a thermally stable and low-cost catalyst, supported NiMo or CoMo type, for gasoline and diesel HDS, without requiring severe conditions to produce ultra-low sulfur fuels.

The CoMo or NiMo catalyst has a low metal loading based on the weight of the impregnated substrate. The preparation method of this catalyst promotes an optimized morphology and dispersion in the nanostructure of MoS₂ and Co(Ni)MoS₂, which determine the capacity for HDS processing of diesel or gasoline.

The preparation method also includes the addition of zeolite nanocrystals to the support to enhance HDS activity and promote selectivity toward the direct desulfurization route.

The document protects the preparation method that comprises precursors from organic acids and metal salts and a support containing an ultra-stable Y-type zeolite. The organic acids can be malic, oxalic and/or citric acid, the metal salts are from group VI and preferably are Mo trioxide, molybdic acid, ammonium heptamolybdate and equivalent compounds of W, metal salts of Co or Ni, such as nitrates, acetates and phosphates.

The catalyst is useful in the hydrotreatment of a heavy diesel fraction with 36000 ppm sulfur and 1400 ppm nitrogen, a light cyclic oil fraction with 22000 ppm sulfur and 400 ppm nitrogen is also included.

The catalytic evaluation with light gas oil (SRGO) of the Madero City Refinery with 20,000 ppm of sulfur and 400 ppm of nitrogen in a packed bed continuous flow reactor, with SiC, in an H₂ atmosphere at a pressure of 40 bar and LVH of 2 h⁻¹, allowed obtaining diesel with 1420 ppm of sulfur at 320° C. and 130 ppm of sulfur at 360° C.

Patent document MX 2014008204 deals with the synthesis of a supported catalyst for catalytic hydrotreatment, where the support is a pure aluminum oxide or mixed with another oxide such as titanium dioxide in the form of nanotubes. The novelty of this invention is that the catalyst can be synthesized without support. The catalyst comprises in its composition a metal from group VIB and/or a metal from group VIIIB of the periodic table and is prepared hydrothermally to obtain it in its sulfided form in a single synthesis step, using a sulfiding substance that has affinity with the metallic composition. The metal of group VIB is Mo with a MoS₂ content>15%, the support is an aluminum oxide in its gamma phase or titanium dioxide in the form of nanotubes in a proportion of 15 wt %.

The catalyst carries out the HDS reaction of primary light gas oil at a temperature of 300 to 400° C., partial pressure of H₂ of 3 to 10 MPa, obtaining a conversion of at least 70%.

As described in the previous patents, the usage of liquid hydrogen transfer agents such as tetralin or decalin to prevent coke formation in crude oil upgrading is well known; However, these compounds are expensive and difficult to recover and reuse. This disadvantage can be overcome with the use of a solid hydrogen transfer agent such as those described in patent MX/a/2014/013477 (USP 862,658 B2) which refers to the use of naphthalene-based polymers or copolymers, particularly polyester type polymers with naphthalene units and USP patent 10077334 B2 describes their application for the improvement of heavy crude oils, in the review patents were found referring to the use of combined beds of catalysts to obtain DUBA, but they were not have found reports of the application of combined beds formed by solid hydrogen donors or solid hydrogen transfer agents with HDS catalysts. Solid Hydrogen Transfer Agents promote pre-hydrogenation in the hydrodesulfurization process of SRGO and/or cuts and streams obtained from the distillation of crude oil such as naphtha, jet fuel, kerosine, and/or a mixture of them, thus facilitating the removal of refractory sulfur compounds to obtain diesel with less than 30 ppm of sulfur, object of the present disclosure.

### SUMMARY OF THE DISCLOSURE

The present disclosure describes a new application of the Mexican patent MX/a/2014/013477 “Use of polymers as heterogeneous hydrogen donors for hydrogenation reactions”, this new application refers to the use of a polyester-type polymer with units that contain the structure of naphthalene, phenanthrene or anthracene, which are not catalysts (they do not contain metals in their chemical structure) and that in a bed combined with an HDS catalyst allows obtaining diesel with less than 30 ppm.

The solid hydrogen transfer agents object of this disclosure display melting temperatures and/or decompositions higher than those described in Mexican patent MX/a/2014/013477. These polymers with units containing the structure of naphthalene, phenanthrene or anthracene are mixed or physically anchored with an inert support such as alumina, boehmite, SiO₂, kaolin, ZiO₂, TiO₂ for industrial application and have physical-chemical and textural properties suitable for carrying carry out the hydrodesulfurization process of cuts and currents obtained from petroleum, and/or blends of them.

The SHTA object of the disclosure has the properties shown in Table 1.

TABLE 1
Molecular weight and textural properties of the SHTA of the present disclosure

| | | | Fresh | Activated |
|---|---|---|---|---|
| | Boehmite | Polymer | SHTA | SHTA |
| Specific Surface Area, m²/g | 209.1 | 8.631 | 200.6 | 118.5 |
| Total pore volume, cm³/g | 0.3887 | 0.01476 | 0.2042 | 0.2819 |
| Average pore diameter,, ° A | 74.37 | 68.42 | 40.72 | 95.17 |
| Average Molecular Weight | | 173,843 | 83,518 | 49,231 |
| (Mn) g/mol | | | | |
| Radial Crush Strength, | | | 13.6 | 10.3 |
| N/mm | | | | |

It is therefore an advantage of this disclosure a new application of these Solid Hydrogen Transfer Agents prepared from a polymer with units containing the structure of naphthalene, phenanthrene or anthracene, carrying out the prehydrogenation of sulfur compounds present in SRGO, cuts or streams obtained from petroleum and/or a mixture of them, in the hydrodesulfurization process when they are mixed or combined with ULSD or non-ULSD Hydrotreatment catalysts, to facilitate the removal of refractory sulfur compounds that are difficult to eliminate for the obtaining Ultra Low Sulfur Diesel

Another advantage of this disclosure is the application of these solid hydrogen transfer agents prepared from a polymer with units containing the structure of naphthalene, phenanthrene or anthracene as Solid Hydrogen Transfer Agents in beds with ULSD Hydrotreatment catalysts or not ULSD to carry out hydrodesulfurization in cuts or streams obtained from oil and/or mixtures thereof.

One more advantage of this disclosure is that in a combined bed formed by a Hydrodesulfurization catalyst/Solid Hydrogen Transfer Agents (HDS/SHTA), the amount of ULSD or non-ULSD Hydrodesulfurization catalyst can be replaced by 20-40%. in loading a fixed bed reactor with a Solid Hydrogen Transfer Agent. ULSD catalysts are expensive and difficult to prepare, SHTA is 40% cheaper than a ULSD catalyst, and with this combined bed it is possible to obtain diesel with less than 30 ppm of sulfur with significant savings.

One more advantage of this disclosure is that with the combined bed formed by ULSD or non-ULSD Hydrodesulfurization catalyst and a Solid Hydrogen Transfer Agents (SHTA), Ultra Low Sulfur Diesel (ULSD) can be obtained when final temperature SRGO is used. boiling up to 382° C. and in petroleum cuts or streams such as jet fuel, kerosine and naphtha and/or mixtures thereof.

In one aspect, the present disclosure provides a composition comprising a solid hydrogen transfer agent (SHTA) for use in beds combined with an ultra-low sulfur diesel (ULSD) or non-ULSD hydrodesulfurization (HDS) catalyst, to obtain ultra-low sulfur diesel in cuts and/or streams derived from petroleum and/or mixtures thereof.

In one embodiment, the cuts and/or streams derived from petroleum are selected from the group consisting of straight run gas oils (SRGO), kerosene, jet fuel, and gasoline.

In one embodiment, the SHTA is prepared from a polymer with units containing a structure of naphthalene, phenanthrene or anthracene that can be supported, anchored or in physical mixture with metal oxides selected from the group consisting of alumina, silica, titania, kaolin, and mixtures thereof.

In one embodiment, the SHTA comprises a specific area between 100-300 m²/g, pore volume between 0.20 and 0.80 cm³/g and average pore diameter 90 to 150 Å, average molecular weight between 30,000 and 80,000 g/mol, radial crush strength between 4 and 15 N/mm, and thermal stability between 400 and 600° C.

In another aspect, the present disclosure provides a process for preparing the composition of the present disclosure.

In certain embodiments, this process involves the following steps:
a) synthesis and purification of the polymer with a naphthalene, phenanthrene or anthracene structure, preferably naphthalene;
b) grinding the pure polymer in a porcelain mortar and passing through a 165 mesh (0.089 mm) sieve;
c) grinding in a porcelain mortar aluminum oxide hydroxide (AlO(OH)) (boehmite), SiO₂, or Al₂O₃ or kaolin, or a mixture thereof, and passing through a sieve, 165 mesh (0.089 mm);
d) preparation of the physical mixture to be extrudated comprising: adding 20 to 100 ml of distilled water to 60 g of grinded and sieved boehmite and mixing to form a paste, subsequently, peptizing by adding 10-50 ml of an aqueous solution of 5-15% nitric acid by volume to form a gel, and afterwards, incorporating 10 to 150 g of a polymer with units containing the naphthalene structure, previously pulverized, stirring until a material with properties suitable for extruding is obtained;
e) extrusion of the physical mixture AlO(OH)-polymer with naphthalene structure, wherein the paste obtained in step d) is placed in a mechanical extrusion system at a constant speed, the extrudates being received in metal trays, and the extrudates being dried 12 to 30 hours at room temperature;
f) preparation of SHTA for the preactivation process with a reducing agent selected from the group consisting of hydrogen, methane, and natural gas, wherein the preparation comprises cutting the material to the desired length and placed into an oven at 90° C. for 12 hours; and
g) preactivation of SHTA at a pilot plant.

In one embodiment of this process, the step g) of preactivation of SHTA at the pilot plant comprises: loading the SHTA into a fixed bed reactor, wherein in a first curing stage the temperature is increased from room to 350-550° C. and pressure from atmospheric to 20-100 kg/cm², maintaining N₂ flowing at 10 to 50 LSPH, wherein these conditions are kept constant for 20-50 h, wherein after this curing stage, the temperature is lowered to room temperature and the pressure to 1 kg/cm², and then the flow of nitrogen is changed to hydrogen to start SHTA activation, which is performed with the same temperature and pressure conditions but using flowing hydrogen instead of nitrogen, and wherein activation stage conditions are kept for 2-50 h, and wherein the reactor is then cooled to room temperature and the SHTA is unloaded.

In another aspect, the present disclosure provides a process for obtaining ultra-low sulfur diesel (ULSD) with a combined bed formed by a ULSD or non-ULSD hydrodesulfurization (HDS) catalyst and solid hydrogen transfer agent (SHTA).

In certain embodiments, this process involves the following steps:
a) packing a fixed bed reactor of an HDS pilot plant with a combined bed formed by an ULSD or non-ULSD HDS catalyst and the preactivated SHTA, wherein the ratio comprises 10-90% volume of the catalyst and 10-90% volume of the SHTA with variable setting of the beds;
b) simultaneous activation of the combined bed formed by an ULSD or non-ULSD HDS catalyst and the preactivated SHTA by any method used in the activation of HDS catalysts; and
c) evaluation of the HDS activity of the previously activated combined bed, using cuts and/or fractions of the oil as feed, and/or a blends thereof selected from the group consisting of naphtha, straight run gas oils (SRGO), kerosine, jet fuel, and gasoline, wherein the reaction is carried out in the presence of a reducing agent selected from the group consisting of hydrogen, methane, and natural gas, at a temperature between 300 and 450° C., pressure of 20 to 70 Kg/cm², liquid hourly space velocity (LHSV) between 0.5 and 2 h⁻¹ for carrying out the HDS reaction and obtaining ULSD.

With aim purpose of achieving an understanding of the application of Solid Hydrogen Transfer Agents that are polymers with the structure of naphthalene, phenanthrene or anthracene supported or physically mixed with an inert support such as alumina, boehmite, SiO₂, kaolin, ZiO₂, TiO₂, etc., for industrial application in the hydrodesulfurization process, based on the use of combined beds formed by Hydrodesulfurization catalyst/Solid Hydrogen Transfer Agent (SHTA), where the SHTA is preactivated with a reducing agent such as hydrogen, methane or natural gas and that in a mixture with an Ultra Low Sulfur Diesel Hydrodesulfurization (ULSD) or non-ULSD catalyst can be activated simultaneously in a fixed bed reactor by methods used for the activation of known Hydrodesulfurization catalysts, without modifying their chemical structure, or textural properties, thermal stability or activity, to obtain diesel with ultra-low sulfur content, when SRGO is used as a filler alone, or in a mixture with cuts or currents obtained from petroleum such as naphtha, jet fuel, kerosine, etc. object of the present disclosure, reference will be made to the figures presented below, without limiting their scope.

### BRIEF DESCRIPTION OF THE DRAWINGS

FIG. 1 shows the chemical structure of the polyester-type polymer with units containing the naphthalene structure used in the preparation of the Solid Hydrogen Transfer Agent object of the present disclosure (USP 862,658 B2).

FIG. 2 shows X-ray diffraction pattern for the polyester-type polymer containing naphthalene structure, which is used as raw material for the synthesis of the Solid Hydrogen Transfer Agent (SHTA), also the pattern for fresh SHTA and for the SHTA after activation with hydrogen. It can be observed the change of structure from boehmite to alumina.

FIG. 3 shows the IR spectrum of the polyester-type polymer containing a naphthalene structure, a signal is observed at 1695 cm⁻¹ due to the ester carbonyl group of the Poly-(1,4-bis(1,5-naphthalenedioxy) benzenedicarboxylate) polymer, which remains after activation with hydrogen.

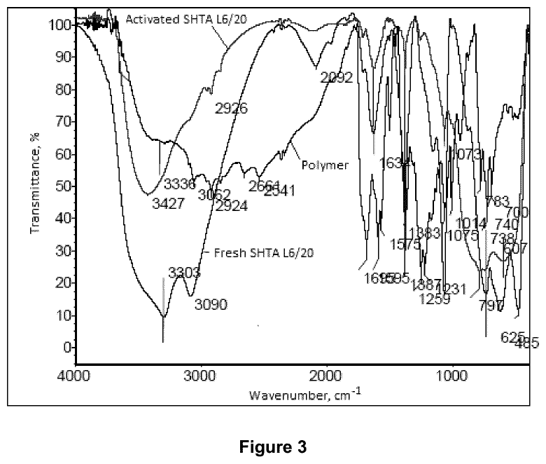

FIG. 4 shows the thermogravimetric analysis of the Solid Hydrogen Transfer Agent (SHTA) pre-activated with hydrogen determined in an air environment, where it is observed that the pre-activated SHTA has a thermal stability higher than the reaction temperature of the HDS process, which guarantees its usage at industrial level.

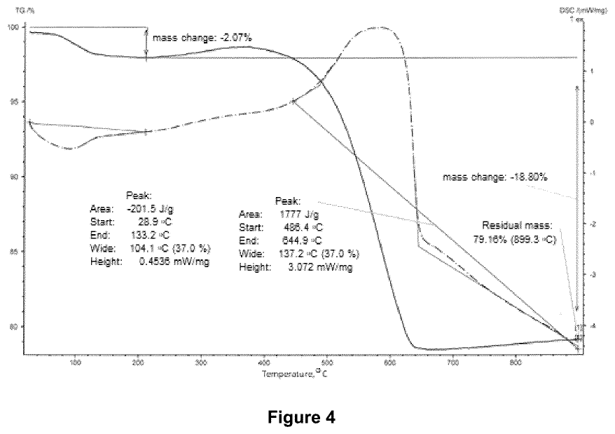

FIG. 5 shows the bed distribution of materials in a fixed bed reactor, comprised by an HDS catalyst and the pre-activated Solid Hydrogen Transfer Agent.

FIG. 6 shows the activity results obtained in a test carried out in a HDS pilot plant with SRGO, where the fixed bed reactor was packed according to the distribution shown in FIG. 5. It is shown at 365° C. and LHSV of 1.0 h⁻¹ it is possible to hydrodesulfurize the SRGO down to 50 ppm sulfur.

FIG. 7 shows the activity results obtained in a test carried out in an HDS pilot plant, with SRGO, where the fixed bed reactor was packed with inert material (SiC). No sulfur was removed during the run time, at the conditions shown in the figure.

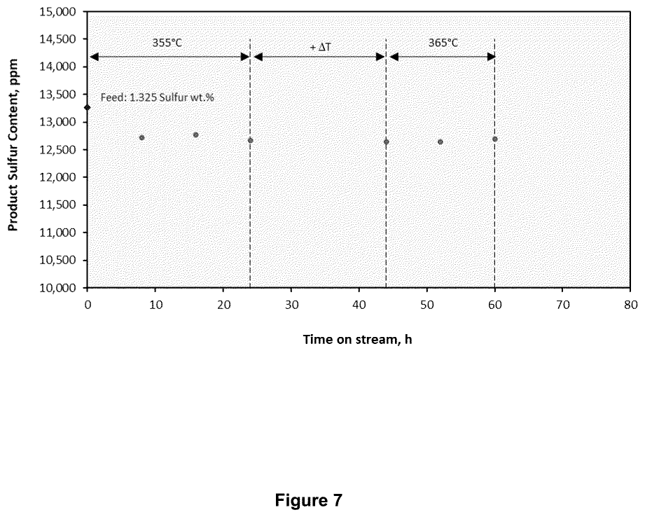

FIG. 8 shows the activity results obtained in a test carried out in a HDS pilot plant, with SRGO, where the fixed bed reactor was packed with a 100% Solid Hydrogen Transfer Agent. As can be seen, SHTA alone cannot hydrodesulfurize SRGO, except in the first hours of the run.

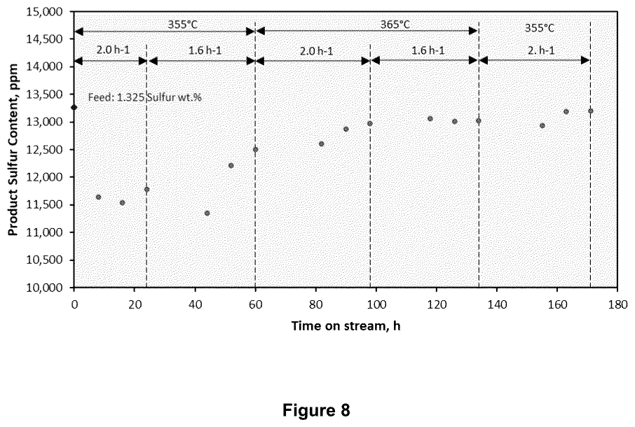

FIG. 9 shows the activity results obtained in a test carried out in an HDS pilot plant, where the fixed bed reactor was packed with a 100% low metal load Ultra Low Sulfur Diesel catalyst. As can be seen, the SRGO is hydrodesulfurized up to 375 ppm at 365° C. and LHSV of 1.6 h⁻¹.

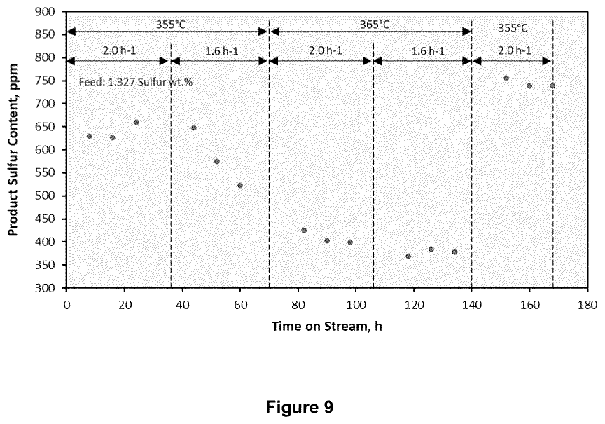

FIG. 10 presents the activity results obtained in a test carried out in an HDS pilot plant with a mixture of jet fuel+kerosine+SRGO as charge, where the fixed bed reactor was packed according to the distribution shown in FIG. 4. As can be seen at 365° C. and LHSV of 1.0 h⁻¹ it is possible to hydrodesulfurize the SRGO up to 10 ppm sulfur and at 355° C. and LHSV of 0.8 h⁻¹ it is possible to hydrodesulfurize the SRGO up to 15 ppm sulfur.

### DETAILED DESCRIPTION

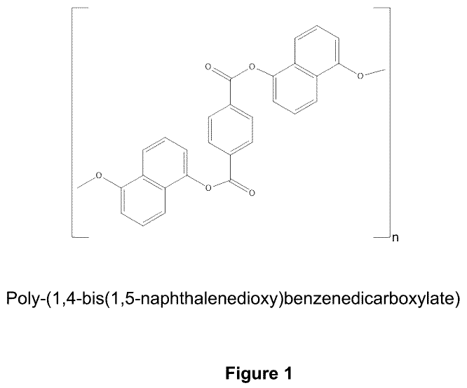

The present disclosure relates to a new application of Heterogeneous Hydrogen Donors (DHH) or Solid Hydrogen Transfer Agents (SHTA) prepared from a polymer with units containing the structure of naphthalene, phenanthrene or anthracene (FIG. 1), which can be supported, anchored or in physical mixture with metal oxides such as alumina, silica, titania or kaolin and/or a mixture of them, to be used in beds combined with a ULSD or non-ULSD HDS catalyst, to obtain ultra-low sulfur diesel. sulfur in cuts and/or streams derived from petroleum such as SRGO, kerosine, jet fuel, naphtha, and/or a mixture thereof. The SHTA of the present disclosure provide an additional amount of hydrogen atoms facilitating the removal of refractory sulfur compounds in the HDS process.

The SHTA are packed in beds combined with an ULSD or non-ULSD HDS catalysts and can be activated simultaneously within a fixed bed reactor by conventional methods in the activation of HDS catalysts, without modifying their physical, chemical or properties. textural features such as: chemical structure, thermal stability, surface area, crushing strength or their activity in the HDS process; in addition, because they are solid, they can be recovered from the reactor and reactivated for subsequent reusage.

An object of the present disclosure is that Solid Hydrogen Transfer Agents (SHTA), prepared from a polymer with units containing the structure of naphthalene, phenanthrene or anthracene, supported, anchored or in physical mixture with metal oxides such as alumina, silica, titania or kaolin and/or a mixture of them have application in any chemical reaction that involves a reduction, such is the case of the HDS reaction, where the SHTA object of the present disclosure are packed in beds combined with a ULSD or non-ULSD HDS catalyst, and can be activated simultaneously within a fixed bed reactor by conventional methods in the activation of HDS catalysts, without modifying their physical-chemical and textural properties such as: chemical structure, thermal stability, surface area, crush strength or its activity in the HDS process.

Another object of the present disclosure is that solid hydrogen transfer agents, prepared from a polymer with units containing the structure of naphthalene, phenanthrene or anthracene, supported, anchored or in physical mixture with metal oxides such as alumina, silica, titania or kaolin and/or a mixture of them are packed in beds combined with a ULSD or non-ULSD HDS catalyst and because they are solids they can be recovered from the reactor and reactivated for subsequent reusage.

A further object of the present disclosure is that solid hydrogen transfer agents, prepared from a polymer with units containing the structure of naphthalene, phenanthrene or anthracene, supported, anchored or in physical mixture with metal oxides such as alumina, silica, titania or kaolin and/or a mixture of them packed in a fixed bed reactor using beds combined with a ULSD or non-ULSD HDS catalyst, have a thermal stability greater than 450° C., which allows the reaction to be carried out of HDS without decomposing, or modifying its chemical structure or textural properties.

Another object of the present disclosure is that solid hydrogen transfer agents, prepared from a polymer with units containing the structure of naphthalene, phenanthrene or anthracene, supported, anchored or in physical mixture with metal oxides such as such as alumina, silica, titania or kaolin and/or a mixture of them, before being used, are pre-activated with a reducing agent such as hydrogen, methane or natural gas, selecting hydrogen, to carry out the hydrogenation of the naphthenic ring of the polymer and move to a tetraline structure, thus facilitating the transfer of hydrogen atoms to the reaction medium; They are subsequently packed in a fixed bed reactor along with a ULSD or non-ULSD HDS catalyst to carry out the HDS reaction.

Another further object of the present disclosure is that solid hydrogen transfer agents, prepared from a polymer with units containing the structure of naphthalene, phenanthrene or anthracene, supported, anchored or in physical mixture with metal oxides such as alumina, silica, titania or kaolin and/or a mixture of them, in beds combined with a ULSD and non-ULSD HDS catalyst, act by carrying out the prehydrogenation of the sulfur compounds present in SRGO and in cuts or currents of petroleum and/or mixture of them, before the HDS process, thus favoring the reduction reactions of aromatic rings, which are limited by the availability of hydrogen that must be transferred to the liquid before starting the hydrogenation reaction, and by the partial pressure of hydrogen. The SHTA of this disclosure provide an additional amount of hydrogen atoms facilitating the elimination of refractory sulfur compounds.

Finally, another object of the present disclosure is that SHTA can be manufactured from commercial and economical raw materials with preparation processes that are easy to scale. The procedure for preparing solid hydrogen transfer agents with units containing the structure of naphthalene, phenanthrene or anthracene, object of the application of the present disclosure, considers the following steps for the preparation of the raw materials:

a) Synthesis and purification of the polymer containing naphthalene, phenanthrene or anthracene structure, preferably naphthalene (Mx/a/2014/013477 patent, 862,658 B2 US Patent, FIG. 1.

b) Grinding the pure polymer in a porcelain mortar and pass through a 165 mesh (0.089 mm) sieve.

c) Grinding in a porcelain mortar AlO(OH) also known as boehmite, SiO₂, or Al₂O₃ or kaolin, or mixture of them, preferably boehmite, mesh through a sieve, 165 mesh (0.089 mm).

d) Preparation of the physical mixture to be extrudated: Add 20 to 100 ml of distilled water to 60 g of grinded and sieved boehmite and mixed to form a paste, subsequently, it is peptized by adding 10-50 ml of an aqueous solution of 5-15% nitric acid by volume to form a gel. Afterwards, incorporate 10 to 150 g of a polymer with units containing the naphthalene structure, previously pulverized, stirring until a material with properties suitable for extruding is obtained.

e) Extrusion of the physical mixture AlO(OH)-polymer with naphthalene structure: The paste obtained in section d) is placed in a mechanical extrusion system at a constant speed, the extrudates are received in metal trays, the extrudates are dried 12 to 30 hours at room temperature

f) Preparation of SHTA for the preactivation process with a reducing agent such as hydrogen, methane or natural gas, preferably hydrogen: Preparation comprises cutting the material to the desired length and placed into an oven at 90° C. for 12 hours

g) Preactivation of SHTA at pilot plant. The SHTA is loaded into a fixed bed reactor, in a first curing stage, temperature is increased from room to 350-550° C. and pressure from atmospheric to 20-100 kg/cm², maintaining N₂ flowing at 10 to 50 LSPH, then these conditions are kept constant for 20-50 h. After this curing stage, the temperature is lowered to room temperature and the pressure to 1 kg/cm², and then the flow of nitrogen is changed to hydrogen to start SHTA activation, which is performed with the same temperature and pressure conditions but using flowing hydrogen instead of nitrogen. Activation stage conditions are kept for 2-50 h. The reactor is then cooled to room temperature and the SHTA is unload.

The solid hydrogen transfer agent obtained in the present disclosure has the following technical characteristics:

A specific area between 100-300 m²/g, pore volume between 0.20 and 0.80 cm³/g and average pore diameter 90 to 150 Å, average molecular weight between 30,000 and 80,000 g/mol, radial crush strength between 4 and 15 N/mm, thermal stability between 400 and 600° C.

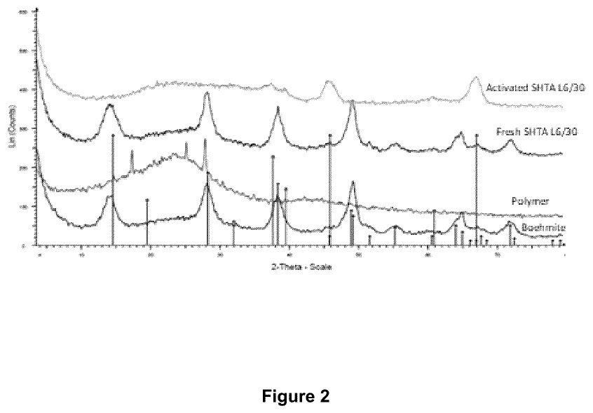

The patent application MX/a/2014/013477, USP 862,658 B2 for the HDS process based on the usage of combined beds comprised by a ULSD or non-ULSD HDS catalyst and an SHTA object of the present disclosure, consists of:
a) Pre-activation the SHTA with a reducing agent such as hydrogen, methane or natural gas, preferring hydrogen, to hydrogenate the naphthalene-type ring of the polymer (FIG. 1) and have a tetraline-type structure, and at the same time carry out the change of the boehmite phase to alumina range of the support used in the preparation of the SHTA at temperatures between 350 and 550° C., pressure between 20 and 100 kg/cm², hydrogen flow between 10 and 50 SLPH, for a period of time between 2 and 50 hours.
b) Loading in a fixed bed reactor of a HDS pilot plant a combined bed formed by a ULSD or non-ULSD HDS catalyst and the pre-activated SHTA, according to the distribution of combined beds shown in FIG. 2.
c) Activation of the combined bed formed by a ULSD or non-ULSD HDS catalyst and the pre-activated SHTA by any method used in the activation of HDS catalysts.
d) Evaluation of the activity of the combined bed formed by a ULSD or non-ULSD HDS catalyst and the pre-activated SHTA, using cuts or fractions of the oil as feedstock, or a mixture of them, such as: SRGO, kerosine, jet fuel or a mixture thereof. The reaction is carried out in the presence of a reducing agent such as hydrogen, methane or natural gas, hydrogen being preferred, at a temperature between 300 and 450° C., pressure of 20 to 70 Kg/cm², LHSV between 0.5 and 2 h⁻¹ to carry out the HDS reaction and obtain ULSD.

### EXAMPLES

Examples related to the application of this disclosure based on the use of combined HDS-SHTA catalyst beds to obtain ULSD are presented below, without these examples limiting the scope of the present disclosure.

### Example 1. Conditioning and Preactivation of the SHTA in a Pilot Plant

This example describes the procedure for the preactivation of the solid hydrogen transfer agent with hydrogen as a reducing agent, in a pilot plant for the hydrotreatment of heavy crude oil.

a) Conditioning of the Solid Hydrogen Transfer Agent

1. —The solid hydrogen transfer agent is placed in a fixed bed reactor, and a tightness test is carried out using N₂ at a pressure of 40 to 80 Kg/cm².

2. —The reactor is heated to 50 to 150° C., feeding a nitrogen flow between 100-500 ml/min, at atmospheric pressure. These conditions are maintained for 2-10 h.

3. —The temperature is increased from 380 to 500° C. and the pressure from 40 to 80 Kg/cm², while flowing N₂ at rate between 100-500 ml/min. These conditions are maintained for 10-24 hours.

4. —The temperature is decreased to 100-150° C., the system is depressurized to atmospheric pressure, maintaining the same nitrogen flow. Maintain these conditions for 2-10 hours.

b) Pre-Activation of the Solid Hydrogen Transfer Agent

1. —The nitrogen flow is replaced by hydrogen at 100-500 ml/min, the pressure is increased from 40 to 80 Kg/cm² and the temperature between 100 and 300° C. at a speed of 20° C./hour. Maintain these conditions for 2 to 10 hours. The hydrogen flow is maintained, and the temperature is increased to 300-500° C., at a rate of 30° C./hour. Maintain these conditions for 10-50 hours.

2. —The temperature is decreased to 100-150° C. at a rate of 50° C./hour, maintaining the same hydrogen flow and system pressure. When reaching 100-150° C., replace the H₂ flow with N₂. Maintain conditions for 1 to 10 hours.

3. —The system pressure is reduced to atmospheric, maintaining the nitrogen flow between 100 and 500 ml/min. Maintain conditions between 2-10 hours. After this time, reduce the temperature to room temperature at a rate of 50° C./hour, maintaining the N₂ flow.

### Example 2. Optimal Distribution of Combined Bed: ULSD HDS Low Metal Loading Catalyst with and the Solid Hydrogen Transfer Agent (SHTA)

An ULSD catalyst with low metal loading and pre-activated SHTA was loaded into a fixed bed reactor to obtain ULS diesel. To define the distribution of the HDS and SHTA catalyst, it was required to obtain the kinetic parameters for the hydrodesulfurization performed by the catalyst and the hydrogenation of the sulfur compounds executed by the SHTA. Kinetic information is necessary to carry out the simulation of the catalyst beds and SHTA.

To obtain kinetic data for the catalytic hydrodesulfurization, several tests were carried out at the pilot plant level, then numerical analysis were made to obtain kinetic parameters based on kinetic models reported in the literature.

The tests performed included:
1) Test with a catalytic bed comprised by 100% of low metal loading of a ULSD HDS catalyst.
2) Reference thermal test. Catalytic bed packed with an inert material.
3) Test with a bed comprised by 100% SHTA.

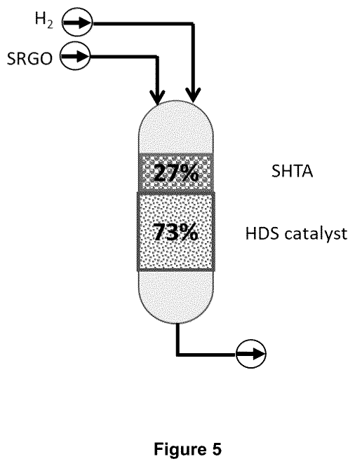

Based on the kinetic parameters obtained, numerical simulations were made with the aim to obtain a product with 30 ppm of sulfur at the following operating conditions: T=355° C., P=54 kg/cm², LHSV=1.0, and SRGO as feedstock. Optimal reactor distribution obtained of beds consisting of SHTA and ULSD HDS low metal loading catalyst resulted in the 27/73% volume ratio, as shown in FIG. 5.

### Example 3. Activation of the Combined Bed: ULSD HDS Low Metal Loading Catalyst—Solid Hydrogen Transfer Agent (SHTA)

In a fixed bed reactor, an ULSD low metal content catalyst and pre-activated SHTA were loaded to obtain ULS diesel, according to the distribution in FIG. 5. Then inlet temperature to the reactor is increased from ambient to 100-160° C. at a speed of 10-30° C./h, this temperature, and a pressure of 40-80 kg/cm², and flowing hydrogen at 25-100 L/h rate are maintained for 1-10 h.

Temperature is increased from 100-300° C. at a rate of 10-30° C./h, this temperature and a pressure of 40-80 kg/cm² are maintained for a period of time of 1-20 h, while gas and liquid are fed. Gas flowing comprising hydrogen 25-150 L/h and a liquid consisted of sulfiding agent (feedstock 1), whose specific weight 20/4° C. is 0.8328 g/ml. After this stage, feedstock 1 flowing is suspended, and changed for feedstock 2 owing a specific weight 20/4° C. is 0.8328 g/ml, these conditions are maintained for a period of 1-20 h. The materials contained in the beds activated in situ are prepared to subsequently carry out its evaluation in the HDS of feedstock consisting of pure SRGO or blends such as Jet Fuel+Kerosine+SRGO.

### Example 4. Effect of Combined Bed ULSD HDS Low Metal Loading Catalyst—Solid Hydrogen Transfer Agent Using SRGO as Feedstock

In a hydrodesulfurization pilot plant, a test lasting 170 h was carried out, the reactor was packed with a bed formed by 27% ml of SHTA and 73 ml of an ULSD low metal loading catalyst, as shown in FIG. 5. Operating conditions included temperature of 355 and 365° C., pressure of 54 kg/cm², LHSV of 1.0 to 1.6 h⁻¹ and SRGO as feedstock with a total sulfur content of 1.325% weight and API gravity equals to 32.6. The following results were obtained:
At 365° C. and LHSV of 1.0 h⁻¹, it is possible to hydrodesulfurize the SRGO as low as 55 ppm sulfur.
Gaining of API gravity of 3.5 degrees

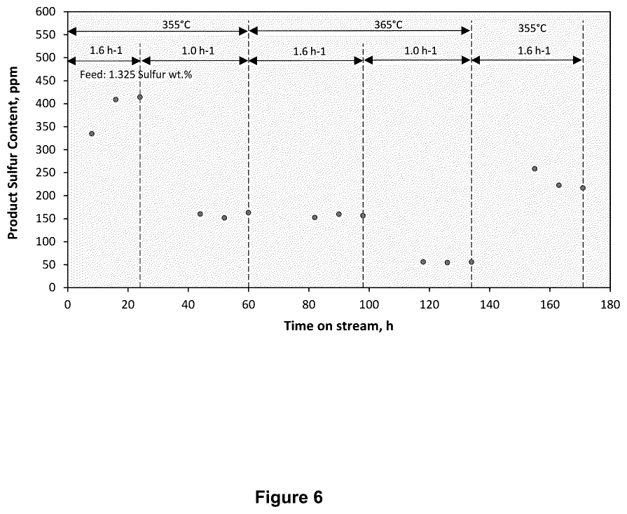

The results obtained are presented in FIG. 6.

### Example 5. Effect of Combined Bed ULSD HDS Low Metal Loading Catalyst—Solid Hydrogen Transfer Agent Using a Jet Fuel—Kerosine and SRGO Blend as Feedstock

Before unloading the reactor, the test of example 4 was continued by changing the SRGO feed for a blend formed by jet fuel+kerosine+SRGO with a total sulfur content of 1.057% weight and API gravity of 35.6. The operating conditions evaluated included: temperature of 355 and 365° C., pressure of 54 kg/cm², LHSV of 0.8 to 1.6 h⁻¹. The following results were obtained:
At 365° C. and LHSV of 1.0 h⁻¹ it is possible to achieved deep hydrodesulfurization of the feed to a sulfur level of 7.5 sulfur ppm.
At 355° C. and LHSV of 0.8 h⁻¹ it is possible to diminish the sulfur level of the feed to 15.5 sulfur ppm.
Gaining of API gravity of 3.2 degrees

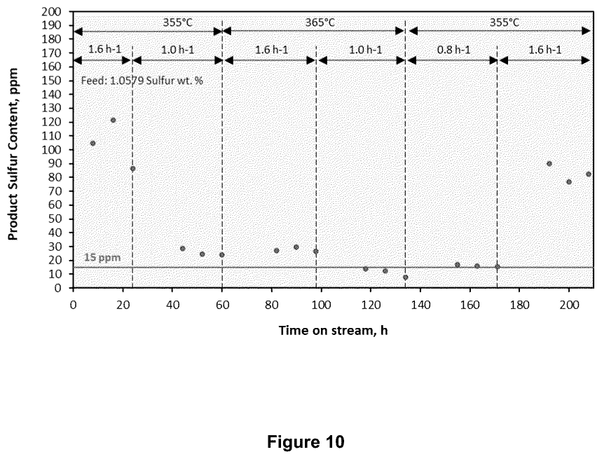

The results obtained are presented in FIG. 10.

The following references provide further background:
[1] Johnstone R. A. W., Wilby A. H., Entwistle I. D. Chem. Rev., 1985, 85, 129-170.
[2] Brieger G., Nestrick T. J. Chem. Rev., 1974, 74, 567-580.
[3] Rylander P. N. Catalytic Hydrogenation in Organic Syntheses, Academic Press, Inc., San Diego, 1979.
[4] Carlson C. S., Langer A. W., Stewart J., Hill R. M. Ind. Eng. Chem., 1958, 50, 1067-1070.
[5] Akash B. A. Int. J. of Thermal & Environmental Engineering, 2013, 5, 51-60.
[6] Asrar J., Toriumi H., Watanabe J., Krigbaum W. R., Ciferri A. J. Polym. Sci. Polym. Physics Ed., 1983, 21, 1119-1131.

1. A composition comprising a solid hydrogen transfer agent (SHTA) for use in beds combined with an ultra-low sulfur diesel (ULSD) or non-ULSD hydrodesulfurization (HDS) catalyst, to obtain ultra-low sulfur diesel in cuts and/or streams derived from petroleum and/or mixtures thereof.

2. The composition according to claim 1, wherein the cuts and/or streams derived from petroleum are selected from the group consisting of straight run gas oils (SRGO), kerosene, jet fuel, and gasoline.

3. The composition according to claim 1, wherein the SHTA is prepared from a polymer with units containing a structure of naphthalene, phenanthrene or anthracene that can be supported, anchored or in physical mixture with metal oxides selected from the group consisting of alumina, silica, titania, kaolin, and mixtures thereof.

4. The composition according to claim 3, wherein the SHTA comprises a specific area between 100-300 m²/g, pore volume between 0.20 and 0.80 cm³/g and average pore diameter 90 to 150 Å, average molecular weight between 30,000 and 80,000 g/mol, radial crush strength between 4 and 15 N/mm, and thermal stability between and 600° C.

5. A process for preparing the composition according to claim 3, comprising the following steps:
a) synthesis and purification of the polymer with a naphthalene, phenanthrene or anthracene structure, preferably naphthalene;
b) grinding the pure polymer in a porcelain mortar and passing through a mesh (0.089 mm) sieve;
c) grinding in a porcelain mortar aluminum oxide hydroxide (AlO(OH)) (boehmite), SiO₂, or Al₂O₃ or kaolin, or a mixture thereof, and passing through a sieve, 165 mesh (0.089 mm);
d) preparation of the physical mixture to be extrudated comprising: adding to 100 ml of distilled water to 60 g of grinded and sieved boehmite and mixing to form a paste, subsequently, peptizing by adding 10-50 ml of an aqueous solution of 5-15% nitric acid by volume to form a gel, and afterwards, incorporating 10 to 150 g of a polymer with units containing the naphthalene structure, previously pulverized, stirring until a material with properties suitable for extruding is obtained;
e) extrusion of the physical mixture AlO(OH)-polymer with naphthalene structure, wherein the paste obtained in step d) is placed in a mechanical extrusion system at a constant speed, the extrudates being received in metal trays, and the extrudates being dried 12 to 30 hours at room temperature;
f) preparation of SHTA for the preactivation process with a reducing agent selected from the group consisting of hydrogen, methane, and natural gas, wherein the preparation comprises cutting the material to the desired length and placed into an oven at 90° C. for 12 hours; and
g) preactivation of SHTA at a pilot plant.

6. The process according to claim 5, wherein the step g) of preactivation of SHTA at the pilot plant comprises: loading the SHTA into a fixed bed reactor, wherein in a first curing stage the temperature is increased from room to 350-550° C. and pressure from atmospheric to 20-100 kg/cm², maintaining N₂ flowing at 10 to 50 LSPH, wherein these conditions are kept constant for 20-50 h, wherein after this curing stage, the temperature is lowered to room temperature and the pressure to 1 kg/cm², and then the flow of nitrogen is changed to hydrogen to start SHTA activation, which is performed with the same temperature and pressure conditions but using flowing hydrogen instead of nitrogen, and wherein activation stage conditions are kept for 2-50 h, and wherein the reactor is then cooled to room temperature and the SHTA is unloaded.

7. A process for obtaining ultra-low sulfur diesel (ULSD) with a combined bed formed by a ULSD or non-ULSD hydrodesulfurization (HDS) catalyst and solid hydrogen transfer agent (SHTA), wherein the process comprises the following steps:
a) packing a fixed bed reactor of an HDS pilot plant with a combined bed formed by an ULSD or non-ULSD HDS catalyst and the preactivated SHTA, wherein the ratio comprises 10-90% volume of the catalyst and 10-90% volume of the SHTA with variable setting of the beds;
b) simultaneous activation of the combined bed formed by an ULSD or non-ULSD HDS catalyst and the preactivated SHTA by any method used in the activation of HDS catalysts; and
c) evaluation of the HDS activity of the previously activated combined bed, using cuts and/or fractions of the oil as feed, and/or a blends thereof selected from the group consisting of naphtha, straight run gas oils (SRGO), kerosine, jet fuel, and gasoline, wherein the reaction is carried out in the presence of a reducing agent selected from the group consisting of hydrogen, methane, and natural gas, at a temperature between 300 and 450° C., pressure of 20 to 70 Kg/cm², liquid hourly space velocity (LHSV) between 0.5 and 2 h⁻¹ for carrying out the HDS reaction and obtaining ULSD.
